(19) United States
(12) Patent Application Publication
(10) Pub. No.: US 2007/0295151 A1
(43) Pub. Date: Dec. 27, 2007

(54) Steering wheel having pivoting rim

(76) Inventor: Boris Kentor, Pittsburgh, PA (US)

Correspondence Address: KIRKPATRICK & LOCKHART PRESTON GATES ELLIS LLP, 535 SMITHFIELD STREET, PITTSBURGH, PA, 15222, US

(21) Appl. No.: 11/435,121

(22) Filed: May 16, 2006

(51) Int. Cl. B62D 1/04; G05G 1/10

(52) U.S. Cl. 74/552

(57) ABSTRACT

A steering wheel for use with a motor vehicle. The steering wheel includes a rim connected to a hub. The rim includes a first rim portion, a second rim portion, and at least one joint joining the first rim portion to the second rim portion. The first rim portion is moveable about the at least one joint between a non-pivoted position and a pivoted position.

### TECHNICAL FIELD OF THE INVENTION

The present invention relates generally to steering wheels for use with motor vehicles.

### BACKGROUND OF THE INVENTION

Automobiles incorporate numerous ergonomic features for increasing ease of use and driver comfort. Such features are frequently designed with the average-sized driver in mind, however, and may not adequately address needs of overweight or otherwise large drivers in certain instances. Although many automobiles are suitably equipped for comfortably accommodating larger drivers when in the driving position, transitioning to and from the driving position is often problematic due to the limited clearance between the steering wheel and the driver's seat. In particular, passage of the driver's body between the steering wheel and driver's seat typically results in contact of the driver's midsection with a lower portion of the steering wheel, causing driver discomfort and increased exertion. Although power tilt and telescopic steering columns and automatic seat adjustment features may be utilized for temporarily increasing the separation between the steering wheel and driver's seat, the additional clearance may be insufficient to provide a satisfactory degree of relief, and the need to readjust such features subsequent to assuming the driving position may be inconvenient. Additionally, such features are mechanically complex and may significantly increase automobile cost.

### BRIEF SUMMARY OF THE INVENTION

This application discloses a steering wheel for use with a motor vehicle. The steering wheel includes a rim connected to a hub. The rim includes a first rim portion, a second rim portion, and at least one joint joining the first rim portion to the second rim portion. The first rim portion is moveable about the at least one joint between a non-pivoted position and a pivoted position.

### BRIEF DESCRIPTION OF THE SEVERAL VIEWS OF THE DRAWINGS FIGURES

FIGS. 1A-1B illustrate front and side views, respectively, of a steering wheel including a first rim portion in a non-pivoted position with respect to a second rim portion according to an embodiment of the present invention;

FIGS. 2A-2B illustrate front and side views, respectively, of the steering wheel when the first rim portion is in a pivoted position with respect to the second rim portion according to an embodiment of the present invention;

FIG. 3 illustrates clearances between a driver's seat and the steering wheel when the first rim portion is in the non-pivoted and pivoted positions with respect to the second rim portion according to an embodiment of the present invention;

FIGS. 4A-4B illustrate front and side views, respectively, of a locking assembly and a pivot joint of the steering wheel when the first rim portion is in the non-pivoted position according to an embodiment of the present invention; and

FIGS. 5A-5B illustrate front and side views, respectively, of the locking assembly and the pivot joint when the first rim portion is in the pivoted position according to an embodiment of the present invention.

FIG. 6 illustrates a front view of the locking assembly and the pivot joint when the first rim portion is in the non-pivoted position and shows an interlock that prevents the locking assembly from disengaging the first rim portion according to an embodiment of the present invention.

FIG. 7 illustrates a front view of the locking assembly and the pivot joint when the first rim portion is in the pivoted position and shows an interlock according to an embodiment of the present invention.

### DETAILED DESCRIPTION OF THE INVENTION

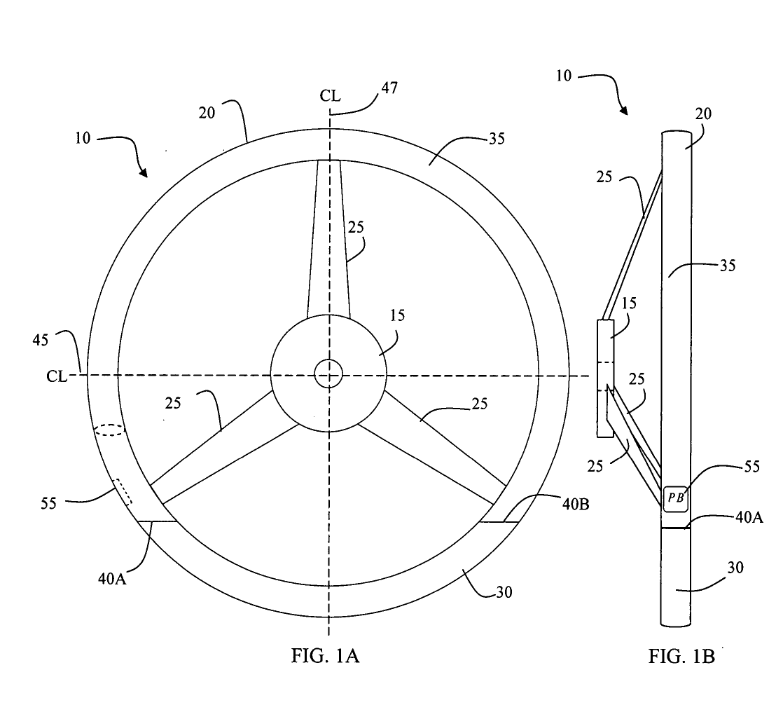

FIGS. 1A-1B illustrate front and side views, respectively, of a steering wheel 10 (also known as a “NORMA” steering wheel) according to various embodiments of the present invention. The steering wheel 10 may comprise a hub 15, a rim 20, and one or more spokes 25 connecting the rim 20 to the hub 15. Although not shown for the sake of clarity, it will be appreciated that the steering wheel 10 may comprise additional components, such as, for example, electrical switches and associated wiring harnesses, an airbag module, a molded covering disposed on the rim 20 for providing a comfortable gripping surface, and a shroud for enclosing the hub 15 and the spokes 25.

According to various embodiments, the hub 15, the spokes 25, and the rim 20 may be fabricated from a suitable metal (e.g., steel, aluminum, magnesium, or combinations thereof) and formed in accordance with conventional steering wheel design criteria. In one embodiment, for example, the spokes 25 may comprise a generally planar geometry and a solid cross-section, and the rim 20 may be generally circular in shape and comprise a tubular cross-section. The hub 15 may be configured for attachment to a steering shaft (not shown) of an automobile in a conventional manner.

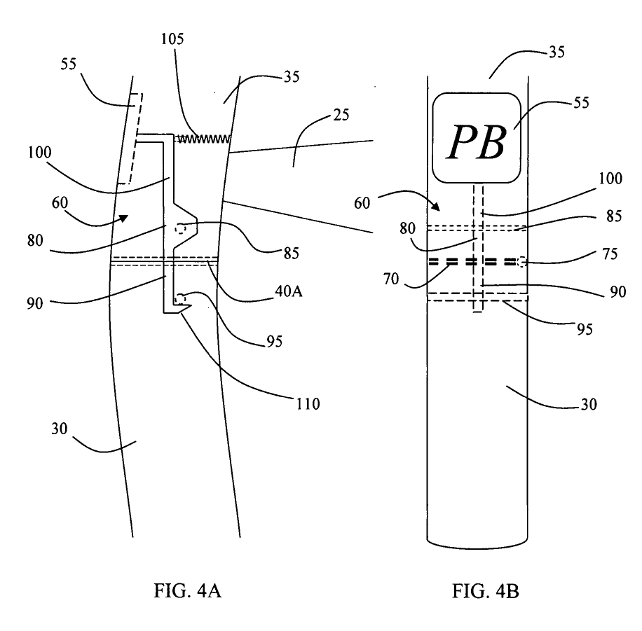

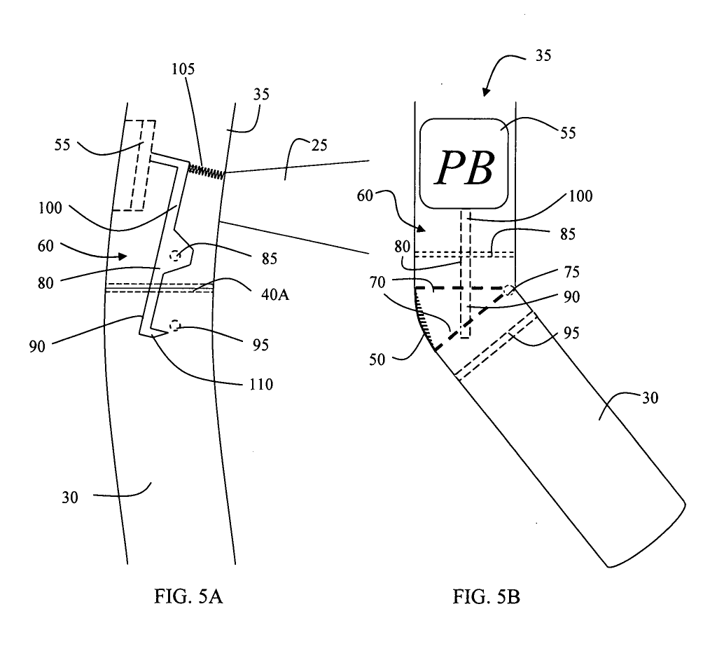

According to various embodiments, the rim 20 may comprise a first rim portion 30, a second rim portion 35, and pivot joints 40A and 40B joining the first rim portion 30 to the second rim portion 35. As discussed below in connection with FIGS. 4A-5B, the pivot joints 40A and 40B may be implemented as hinges, although any device that enables pivotable attachment of one structure to another structure may generally be used. As shown, the first rim portion 30 may comprise at least a portion of the rim 20 that is positioned below the horizontal centerline (CL) 45 of the steering wheel 10 when the steering wheel 10 is in a neutral position (i.e., a position of the steering wheel 10 wherein the wheels of the automobile would result in a straight line of travel). In one embodiment, the second rim portion 35 may comprise the remainder of the rim 20. As best seen in FIG. 1A, the first rim portion 30 may be symmetrically oriented with respect to the vertical CL 47 of the steering wheel 10 and define a bottom portion of the rim 20. It will be appreciated from the discussion below that in some embodiments it is generally desirable to maximize the size of the first rim portion 30 such that it comprises the largest possible portion of the rim 20 below the CL 45. The maximum size of the first rim portion 30 may be limited in certain embodiments, however, by the attachment points of the spokes 25 to the rim 20, or by other mechanical or aesthetic considerations. As shown in FIG. 1A, for example, the size of the first rim portion 30 may be limited to a portion of the rim 20 below the CL 45 and extending between two of the spokes 25.

According to various embodiments, the pivot joints 40A and 40B join the first rim portion 30 to the second rim portion such that the first rim portion 30 is selectively movable between a non-pivoted position and a pivoted position with respect to the second rim portion 35. In FIGS. 1A-1B, the first rim portion 30 is shown in the non-pivoted position. In this position, the first rim portion 30 is generally coplanar with the second rim portion 35 such that the rim 20 is circular in shape, thus permitting the steering wheel 10 to be used in the conventional manner.

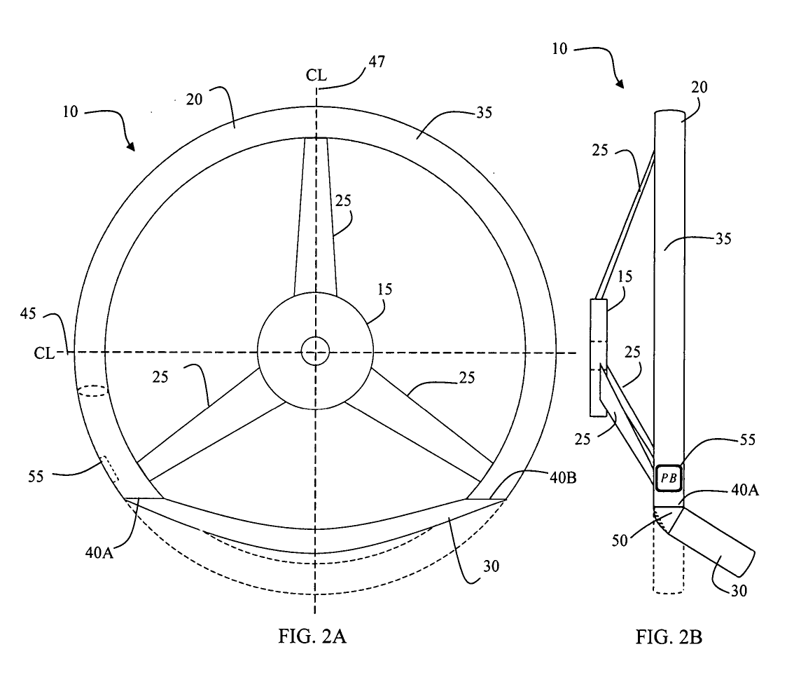

FIGS. 2A-2B illustrate front and side views, respectively, of the steering wheel 10 when the first rim portion 30 is in the pivoted position according to various embodiments. In certain embodiments, the pivot joints 40A and 40B may be configured such that the first rim portion 30 is only pivotable in a direction towards the driver's seat. A flexible shroud 50 (e.g., a rubber sleeve) may be disposed about each of the pivot joints 40A and 40B to minimize their exposure to contaminants (e.g., dust) and to prevent injury to the driver's fingers or hands during their operation. The angle by which the first rim portion 30 is pivoted in FIGS. 2A-2B is shown by way of example only. In certain embodiments, for example, the pivot joints 40A and 40B may be configured such that the first rim portion 30 may be pivoted at any angle between 0 and 180 degrees relative to the second rim portion 35.

As discussed below in connection with FIGS. 4A-5B, movement of the first rim portion 30 from the non-pivoted position to the pivoted position may be initiated by actuating a push button 55 (labeled as “PB”) positioned at a suitable location on the steering wheel 10 (e.g., on the side of the steering wheel 10 most accessible to the driver during entry and exit). Prior to push button 55 actuation, the first rim portion 30 may be engaged by a locking assembly 60 (FIGS. 4A-4B) such that it is locked in the non-pivoted position. Actuation of the push button 55 disengages the first rim portion 30 from the locking assembly 60 (FIGS. 5A-5B), enabling movement of the first rim portion 30 from the non-pivoted position to the pivoted position. The return of the first rim portion 30 from the pivoted position to the non-pivoted position results in the reengagement of the locking assembly 60 such that the first rim portion 30 is once again locked in the non-pivoted position.

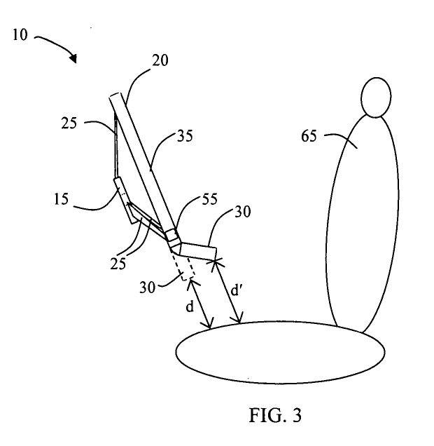

FIG. 3 illustrates clearances between a driver's seat 65 and the steering wheel 10 when the first rim portion 30 is in the non-pivoted and pivoted positions according to various embodiments of the present invention. As shown, the bottom portion of the steering wheel 10 is separated from the driver's seat 65 by a clearance d when the first rim portion 30 is in the non-pivoted position (shown as dashed lines). In the pivoted position the clearance increases to a distance d′. It will be appreciated that the amount by which the clearance is increased is determined by, among other things, the size of the first rim portion 30 relative to the rim 20 and the angle by which the first rim portion 30 is pivoted. The steering wheel 10 of the present invention may be combined with other features such as telescoping or pivoting steering columns and adjustable seats to further increase the clearance between the driver's seat 65 and the steering wheel 10. Advantageously, the increased clearance provided when the first rim portion 30 is in the pivoted position enables overweight or otherwise large drivers to enter into and exit from the driving position with minimal or no interference from the steering wheel 10.

FIGS. 4A-4B illustrate front and side views, respectively, of the pivot joint 40A and the locking assembly 60 when the first rim portion 30 is in the non-pivoted position according to various embodiments of the present invention. Although not shown in FIGS. 4A-4B for the sake of clarity, the pivot joint 40B may be structured and arranged in a manner identical to that of pivot joint 40A. In one embodiment, the pivot joint 40B may have an independent locking assembly associated therewith that is identical to the locking assembly 60. In another embodiment, the pivot joint 40B may have a locking assembly that is mechanically coupled to the locking assembly 60 such that actuation of the push button 55 simultaneously disengages the first rim portion 30 from both locking assemblies. As shown, the pivot joint 40A may be implemented using a conventional hinge comprising two hinge leaves 70 pivotably attached to a hinge knuckle 75 by a pin (not shown). One skilled in the art will appreciate that other types of joints (e.g., knuckle joints, universal joints, pin joints, ball and socket joints, etc.) may alternatively be used. In certain embodiments, at least a part of the pivot joint 40A may be integrally formed on the first and second rim portions 30, 35. As discussed above in connection with FIGS. 2A-2B, the pivot joint 40A may be configured such that the first rim portion 30 is only pivotable in a direction towards the driver's seat. In certain embodiments, the pivot joint 40A may comprise biasing means (not shown), such as a torsion spring, for urging the pivot joint 40A into a pivoted position. The biasing means may alternatively be configured such that the pivot joint 40A is urged into a non-pivoted position.

The locking assembly 60 may comprise a locking member 80 disposed within the rim 20 and pivotably connected to the second rim portion 35 via a pivot pin 85. As shown, a first end 90 of the locking member 80 is configured for selectively engaging a locking pin 95 mounted within the first rim portion 30, and a second end 100 of the locking member 80 is attached to the push button 55. The locking assembly 60 may further comprise biasing means 105 (e.g., a compression spring) for applying a force to the second end 100 of the locking member 80 such that the first end 90 is caused to engage the locking pin 95 in the absence of an opposing force applied to the push button 55. Engagement of the locking pin 95 in this manner thus locks the first rim portion 30 in the non-pivoted position with respect to the second rim portion 35.

FIGS. 5A-5B illustrate front and side views, respectively, of the pivot joint 40A and the locking assembly 60 when the first rim portion 30 is in the pivoted position according to various embodiments of the present invention. Actuation of the push button 55 by the user overcomes biasing means 105 and causes the second end 100 of the locking member 80 to pivot, thus causing disengagement of the locking pin 95 by the first end 90. Accordingly, the first rim portion 30 is no longer locked into place and may be moved into the pivoted position. In embodiments in which the pivot joints 40A and 40B comprise biasing means for urging the first rim portion 30 into its pivoted position, the first rim portion 30 may be caused to automatically move into the pivoted position when the push button 55 is actuated without further assistance by the user. In such embodiments, the user may need to apply a force to the first rim portion 30 sufficient to overcome the pivot joints 40A and 40B biasing means when the first rim portion 30 is returned to its non-pivoted position. In embodiments in which the pivot joints 40A and 40B comprise biasing means for urging the first rim portion 30 into its non-pivoted position, the user may need to apply a force to the first rim portion 30 sufficient to overcome the pivot joint 40A and 40B biasing means in order to move the first rim portion 30 into the pivoted position. In such embodiments, the first rim portion 30 may be caused to automatically move into the non-pivoted position upon its release by the user.

According to various embodiments, the first end 90 of the locking member 80 may comprise a sloped surface 110 that temporarily contacts the locking pin 95 as the first rim portion 30 is transitioned from the pivoted position to the non-pivoted position. Contact of the sloped surface 110 in this manner causes the first end 90 of the locking member 80 to be temporarily rotated until the first rim portion 30 is completely returned to its non-pivoted position. When movement of the first rim portion 30 into its non-pivoted position is complete, biasing means 105 causes the second end 100 of the locking member 80 to pivot. The locking pin 95 is thus re-engaged by the first end 90 of the locking member 80 such that the first rim portion 30 is locked in its non-pivoted position.

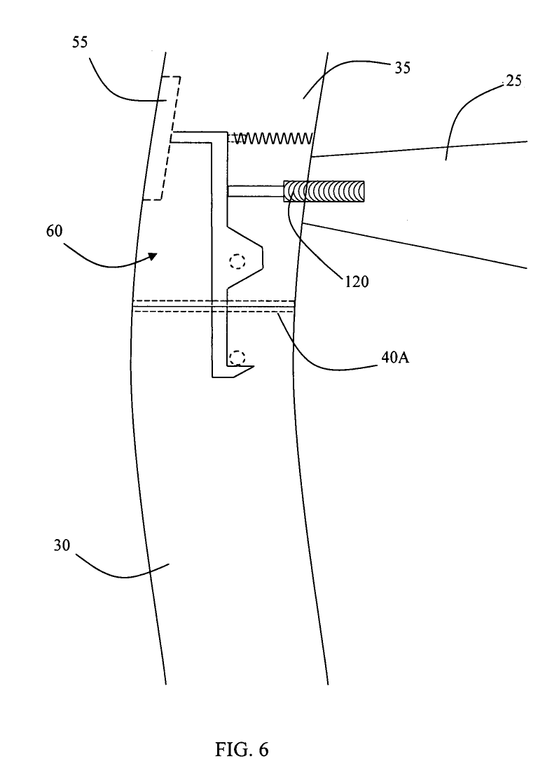

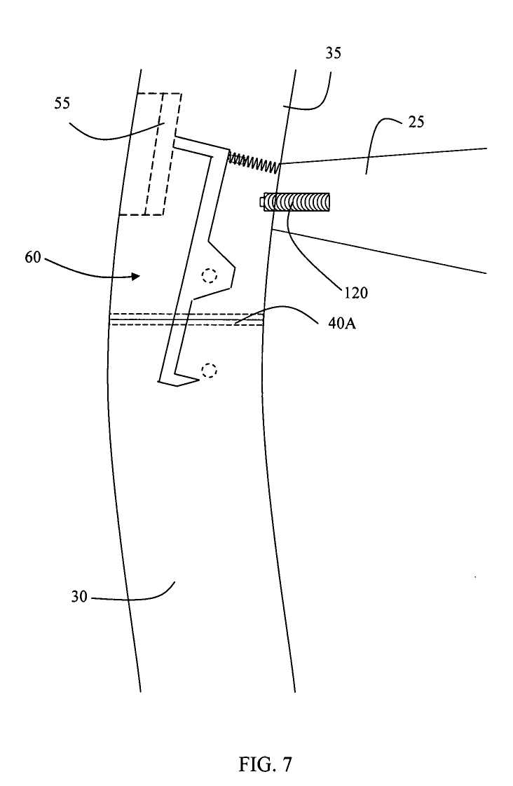

According to various embodiments, the locking assembly 60 may comprise an interlock for preventing actuation of the push button 55 when the vehicle associated with the steering wheel 10 is running. FIGS. 6 and 7 illustrate an interlock 120 that prevents actuation of the push button 55 when the vehicle associated with the steering wheel 10 is running. The interlock 120 prevents the locking assembly from disengaging the first rim portion 30. The interlock may be implemented, for example, using a solenoid or other electromechanical actuator configured to mechanically prevent actuation of the push button 55 under certain conditions.

Whereas particular embodiments of the invention have been described herein for the purpose of illustrating the invention and not for the purpose of limiting the same, it will be appreciated by those of ordinary skill in the art that numerous variations of the details, materials, configurations and arrangement of components may be made within the principle and scope of the invention without departing from the spirit of the invention. The preceding description, therefore, is not meant to limit the scope of the invention.

1. A steering wheel for use with a motor vehicle, comprising:
a hub;
a rim connected to the hub, wherein the rim comprises a first rim portion, a second rim portion, and at least one joint joining the first rim portion to the second rim portion, wherein the first rim portion is moveable about the at least one joint between a non-pivoted position and a pivoted position;
at least one locking assembly for engaging the first rim portion such that the first rim portion is locked in the non-pivoted position, wherein the at least one locking assembly comprises an interlock that prevents the at least one locking assembly from disengaging the first rim portion when the motor vehicle associated with the steering wheel is running; and
biasing means for urging the first rim portion into the pivoted position when each locking assembly is disengaged from the first rim portion.

2. The steering wheel of claim 1, further comprising at least one spoke connecting the rim with the hub.

3. The steering wheel of claim 1, wherein the first rim portion is a portion of the rim below a horizontal centerline of the steering wheel when the steering wheel is in its neutral position.

4. (canceled)

5. The steering wheel of claim 1, further comprising at least one user-actuated push button for disengaging each locking assembly from the first rim portion such that the first rim portion is moveable from the non-pivoted position to the pivoted position.

6-7. (canceled)

8. The steering wheel of claim 5, wherein each locking assembly is further configured to re-engage the first rim portion when the first rim portion is moved from the pivoted position to the non-pivoted position.

9. The steering wheel of claim 1, wherein the interlock comprises an electromechanical actuator.

10. The steering wheel of claim 9, wherein the electromechanical actuator comprises a solenoid.

11. A steering wheel for use with a motor vehicle, comprising:
a hub;
a rim connected to the hub, wherein the rim comprises a first rim portion, a second rim portion, and at least one joint joining the first rim portion to the second rim portion, wherein the first rim portion is moveable about the at least one joint between a non-pivoted position and a pivoted position;
at least one locking assembly for engaging the first rim portion such that the first rim portion is locked in the non-pivoted position, wherein the at least one locking assembly comprises an interlock that prevents the at least one locking assembly from disengaging the first rim portion when the motor vehicle associated with the steering wheel is running; and
biasing means for urging the first rim portion from the pivoted position to the non-pivoted position when each locking assembly is disengaged from the first rim portion.

12. The steering wheel of claim 11, further comprising at least one spoke connecting the rim with the hub.

13. The steering wheel of claim 11, wherein the first rim portion is a portion of the rim below a horizontal centerline of the steering wheel when the steering wheel is in its neutral position.

14. The steering wheel of claim 11, further comprising at least one user-actuated push button for disengaging each locking assembly from the first rim portion such that the first rim portion is moveable from the non-pivoted position to the pivoted position.

15. The steering wheel of claim 11, wherein each locking assembly is further configured to re-engage the first rim portion when the first rim portion is moved from the pivoted position to the non-pivoted position.

16. The steering wheel of claim 11, wherein the interlock comprises an electromechanical actuator.

17. The steering wheel of claim 16, wherein the electromechanical actuator comprises a solenoid.
